(19) United States
(12) Patent Application Publication
(10) Pub. No.: US 2015/0179989 A1
(43) Pub. Date: Jun. 25, 2015

(54) FLEXIBLE BATTERY PACK

(71) Applicants: NingDe Amperex Technology Limited, Ningde City (CN); DongGuan Amperex Technology Limited, Dongguan (CN)

(72) Inventors: Yu LUO, Ningde City (CN); Qiao ZENG, Ningde City (CN)

(73) Assignees: NingDe Amperex Technology Limited, Ningde City (CN); DongGuan Amperex Technology Limited, Dongguan (CN)

(21) Appl. No.: 14/257,262

(22) Filed: Apr. 21, 2014

(30) Foreign Application Priority Data
Dec. 23, 2013 (CN) 201310715269.3

(51) Int. Cl. H01M 2/02; H01M 10/04

(52) U.S. Cl. CPC H01M 2/0202; H01M 10/0436

(57) ABSTRACT

The present invention belongs to the technical field of batteries, and more particularly, relates to a flexible battery pack, comprising a packaging film, an electrolyte filled in the packaging film, and at least two electrically-connected cells encapsulated in the packaging film, wherein at least one of the cells is a flexible cell. Compared with the prior art, the flexible battery pack in the present invention is provided with a flexible cell that serves as the flexible part, so that cell bends at the flexible part so as to avoid the effect of stress on the performances of the cells, improve the stability of the cells and improve the bendability of the battery pack. Furthermore, the flexible battery pack in the present invention is further capable of reducing the phenomenon of irregular bending, lowering the bending pressure of the packaging film and prolonging the service life of the battery pack.

### FIELD OF THE INVENTION

The present invention belongs to the technical field of batteries, and more particularly, relates to a flexible battery pack.

### BACKGROUND OF THE INVENTION

With the technological development of mobile portable devices and the increasing demands of people for mobile portable devices, a rapid rise has emerged in people's demands for secondary batteries that act as an energy supplier for mobile portable devices. As these mobile portable devices become thinner, smaller, and diversified in shape, special-shaped or shape-changeable secondary batteries with high energy density and high discharge voltage have been brought into a hot area of research.

Currently, researching on improving the energy density and discharge voltage of the secondary batteries focuses mainly on the following aspects: 1, battery shape: thin batteries and even ultra-thin batteries are manufactured; and 2, battery material: researching on anode and cathode materials with high energy density or on anode materials with high operating voltage are conducted.

And to meet the diversified demands of mobile portable devices for battery's shape, there are mainly two ways as below: 1. a special-shaped battery is used, for example, disclosed in the Chinese patent application 201210051135.1 is a special-shaped lithium ion battery and a manufacturing method therefor; this special-shaped battery is applicable to mobile portable devices that require special shapes, however, it is not flexible to use for wristwatches and other occasions; and 2. a shape-changeable battery pack is designed, for example, disclosed in the patent application US20130171490A1, filed by Apple, is a flexible battery pack; as shown in FIG. 1 and FIG. 2, a series of batteries 11 are arrayed on a bottom layer 14, then an adhesive layer 13 is arranged between the batteries 11, and a top layer 12 is arranged above the batteries 11; or, at first, the top layer 12 is arranged above the batteries 11 and the bottom layer 14 is arranged below the batteries 11, then the bottom layer 14 and the top layer 12 of each battery 11 are bonded together by the adhesive layer 13 to achieve mutual separation of the batteries 11, in this way, the flexible battery pack is prepared.

However, during bending of the flexible batteries disclosed in this application, the bending degree and bendability of the battery pack will be highly restricted under the effect of stress for the high hardness of the top layer 12 and the bottom layer 14. Meanwhile, influenced by uneven stress, the expected middle cell position 22 (the ideal folding position) will be replaced with an irregular crease, shown as the broken line 23 (the actual folding position) during bending, which could lead to irregular bending of the flexible battery pack, and if this flexible battery pack is used for a long time, the cells will be extruded inside by an external force to further affect the expression of battery performances; and this irregular bending phenomenon could also lead to larger bending area than that under ideal folding, which reduces the energy density of the batteries.

Given that, there is definitely a need to provide a flexible battery pack, in order to improve the bendability, stability and energy density of the battery pack.

### SUMMARY OF THE INVENTION

An object of the present invention is to: provide a flexible battery pack based upon the shortcomings in the prior art, in order to improve the bendability of the battery pack, the battery stability in the battery pack, and the energy density that can be achieved by the battery pack.

To reach the object above, adopted in the present invention is a technical scheme below:

A flexible battery pack comprises a packaging film, an electrolyte filled in the packaging film, and at least two electrically-connected cells encapsulated in the packaging film; at least one of the cells is a flexible cell.

As an improvement of the flexible battery pack in the present invention, the flexible cell has a bendable radian of 0°-180°.

As an improvement of the flexible battery pack in the present invention, the flexible cell has a bendable radian of 10°-120°. The bendable radian within this range not only ensures the safety of the cells, but also prolongs the service life of the cells; furthermore, the demands of some special spaces for the bendability of the cells can be meet perfectly, e.g. smart phone, smart watch, smart clothing, etc.

As an improvement of the flexible battery pack in the present invention, the number of the flexible cell is smaller than the total number of the cells.

As an improvement of the flexible battery pack in the present invention, the packaging film between the cells is provided with a narrowing part, which is used for stress release and extension of the packaging film during bending of the flexible battery pack.

As an improvement of the flexible battery pack in the present invention, a adhesive buffer layer is arranged between the cells.

As an improvement of the flexible battery pack in the present invention, a adhesive buffer layer is arranged between the cell and the packaging film. The arrangement of the buffer layer can effectively reduce the extrusion stress of the cells in the bending process, and can also reduce the short-circuit risk caused by mutual abrasion of the cells in the extrusion process.

As an improvement of the flexible battery pack in the present invention, the material of the adhesive buffer layer is at least one of the group consisting of Acrylic resin, epoxy resin, acrylic ester, styrene-butadiene rubber, ethylene-vinyl acetate copolymer, ethylene-acrylic acid copolymer and polyethylene terephthalate. These materials are resistant to high temperature and anticorrosive, ensuring high safety of the cells in the extrusion process.

As an improvement of the flexible battery pack in the present invention, the packaging film is sealed by a seal adhesive layer.

As an improvement of the flexible battery pack in the present invention, the material of the seal adhesive layer is at least one of the group consisting of polyimide, polypropylene, Acrylic resin, epoxy resin and acrylate. These materials have good adhesive strength.

In the present invention, the cells are connected in series or in parallel, and may also be connected in a mixed way, i.e. connected in both series and parallel. The serial connection can be employed for some power devices with high energy demand; the parallel connection can be employed for some power devices with large current and high voltage; and the mixed connection can be employed for those power devices that require not only high energy, but also large current and high voltage.

The cells in the present invention are winding cells or laminated cells, and may be liquid electrolyte cells or gel electrolyte cells; the flexible battery pack in the present invention is an alkaline battery pack, a lithium ion battery pack or a lithium-sulfur battery pack, and is preferably a lithium ion battery pack with high energy density. Certainly, the cells in the present invention may also be solid electrolyte cells, and in this case, filling of the electrolyte in the packaging film is not needed.

The flexible battery pack in the present invention may be used as an energy supplier for smart watches, smart glasses, smart clothing, mobile phones, notebook computers, tablet computers, etc.

In the present invention, the material of the packaging film is an aluminum laminated film, which comprises a protective layer, an aluminum foil layer and a heat sealing layer; the protective layer and the aluminum foil layer as well as the aluminum foil layer and the heat sealing layer are compounded in an adhesive manner by adhesive layers respectively, the protective layer is PET (polyethylene terephthalate) film, PEN (polyethylene 2,6-naphthalate) film, polycaprolactam film, etc., and the heat sealing layer is polyethylene film, polypropylene film, polyethylene-propylene film or unsaturated acidic polyethylene film.

Compared with the prior art, the flexible battery pack in the present invention is provided with a flexible cell that serves as the flexible part, so that cell bends at the flexible part so as to avoid the effect of stress on the performances of the cells, improve the stability of the cells and improve the bendability of the battery pack. Furthermore, the flexible battery pack in the present invention is further capable of reducing the phenomenon of irregular bending, lowering the bending pressure of the packaging film and prolonging the service life of the battery pack. In addition, external structures introduced into the battery pack for flexible battery can be reduced, such as adhesive layers, thereby increasing the space utilization in the packaging film, further improving the energy density of the batteries, and enhancing the endurance performance of the batteries.

In conclusion, the flexible battery pack in the present invention can bend flexibly without an external encapsulation structure, and is simple in process and high in safety.

### BRIEF DESCRIPTION OF THE DRAWINGS

FIG. 1 is a sectional view of the flexible battery pack in the prior art;

FIG. 2 is a plan view of the flexible battery pack in the prior art;

FIG. 3 is a structural view of the flexible cell in the present invention;

FIG. 4 is a structural view of the common cell in the present invention;

FIG. 5 is a sectional view of the embodiment 1 of the present invention;

FIG. 6 is a sectional view of the embodiment 1 of the present invention after bending;

FIG. 7 is another sectional view of the embodiment 1 of the present invention after bending;

FIG. 8 is a sectional view of the embodiment 2 of the present invention after bending;

FIG. 9 is a sectional view of the embodiment 3 of the present invention after bending;

FIG. 10 is a sectional view of the embodiment 4 of the present invention after bending;

FIG. 11 is a sectional view of the embodiment 5 of the present invention after bending; and

FIG. 12 is a sectional view of the embodiment 6 of the present invention after bending.

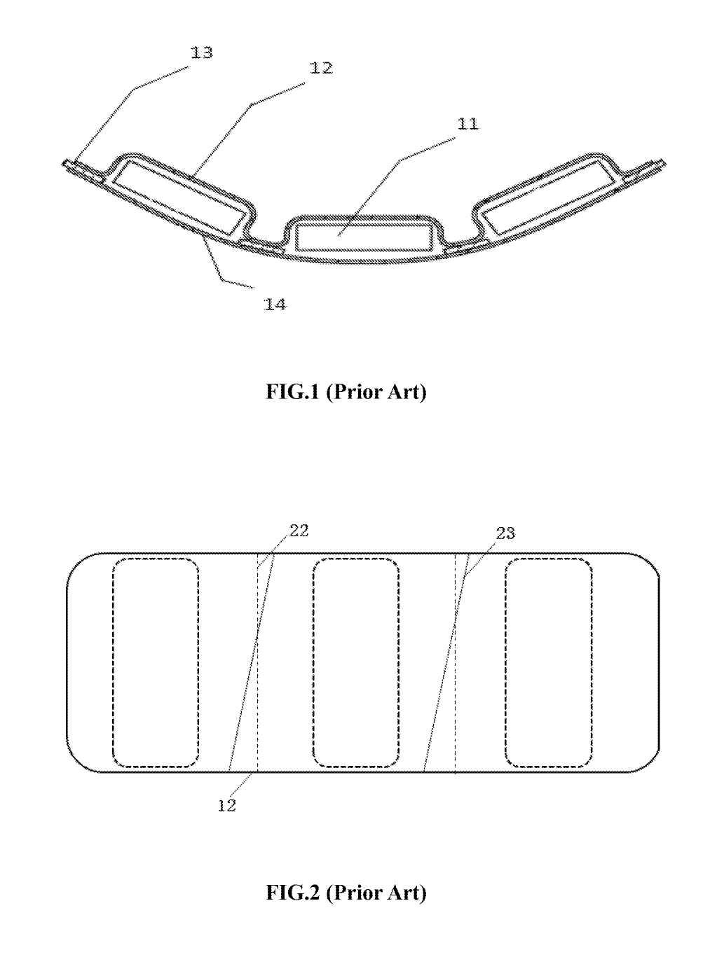

### DETAILED DESCRIPTION OF THE PREFERRED EMBODIMENTS

The present invention and its advantageous effects will be further illustrated below in details by reference to the accompanying drawings and the embodiments, however, the embodiments of the present invention are not limited thereto.

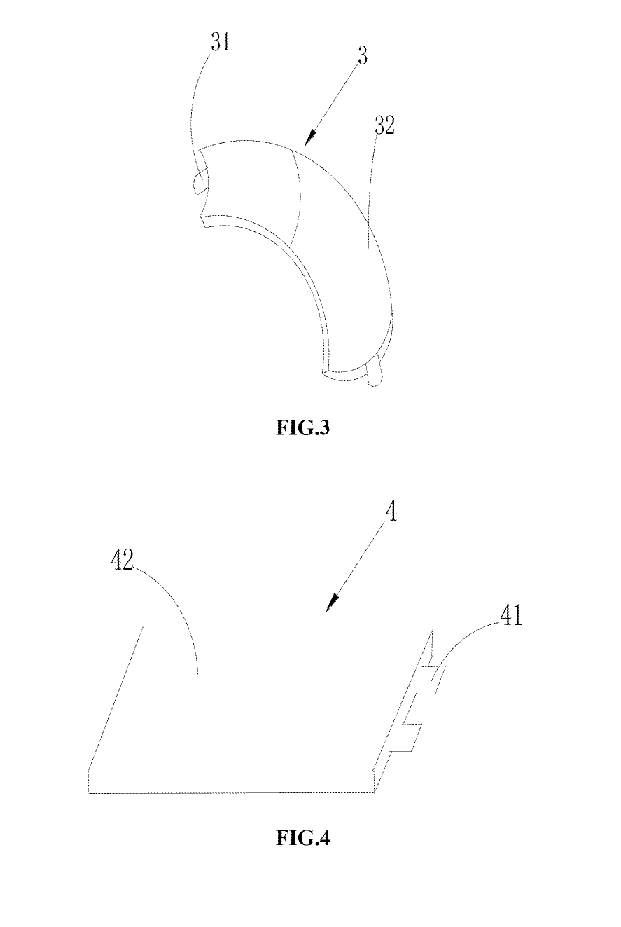

As shown in FIG. 3, a flexible cell 3 in the present invention comprises flexible cell tabs 31 and a flexible cell body 32, and has a bendable radian of 0°-180°, preferably 10°-120°.

As shown in FIG. 4, a common cell 4 comprises common cell tabs 41 and a common cell body 42, and is barely bendable.

During assembly of a battery or a battery pack, the electrolyte used in the flexible cell 3 and the common cell 4 may be liquid electrolyte, gel electrolyte or solid electrolyte; and the flexible cell 3 and the common cell 4 may be alkaline battery cells, lithium ion battery cells or lithium-sulfur battery cells.

Wherein, the flexible cell 3 may be the one that is prepared by the method disclosed in ZL201320260771.5. Certainly, the flexible cell 3 may also be prepared by other methods disclosed in the prior art, only if the prepared cell is flexible (bendable).

### Embodiment 1

As shown in FIG. 5, the flexible battery pack provided in this embodiment comprises a packaging film 5, an electrolyte filled in the packaging film 5, and three electrically-connected cells encapsulated in the packaging film 5. The cells comprise a flexible cell 3 and two common cells 4, the flexible cell 3 has a bendable radian of 60° (i.e. the flexible cell 3 is bendable within a range from 0° to 60°), is located between the two common cells 4 and is respectively connected with the two common cells 4 in series. The packaging film 5 is sealed by a seal adhesive layer 6 that is made of polypropylene, the packaging film 5 is encapsulated by the seal adhesive layer 6 through lamination and screen printing, and the packaging film 5 located between the flexible cell 3 and the common cells 4 is provided with narrowing parts 7, which are used for stress release and extension of the packaging film 5 during bending of the flexible battery pack.

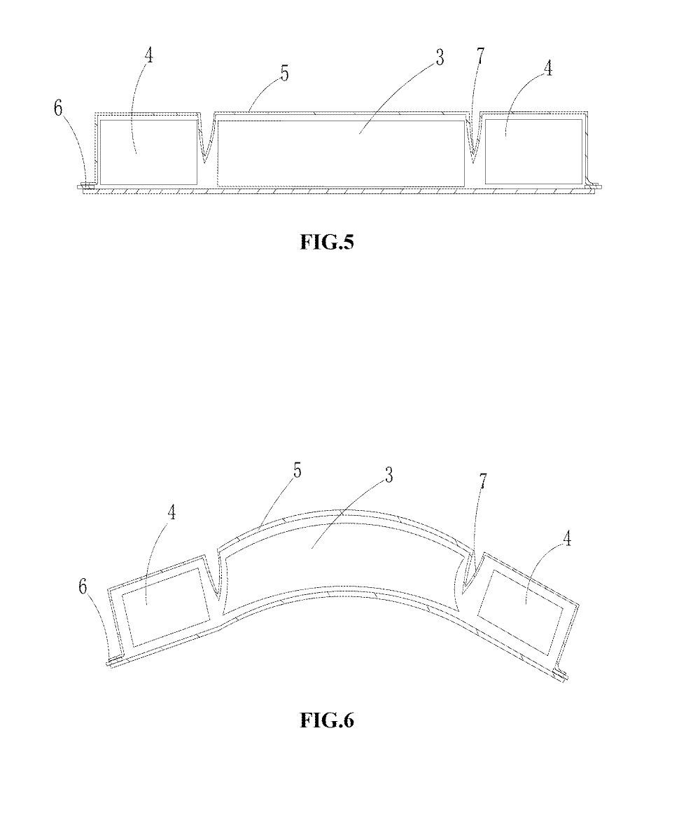

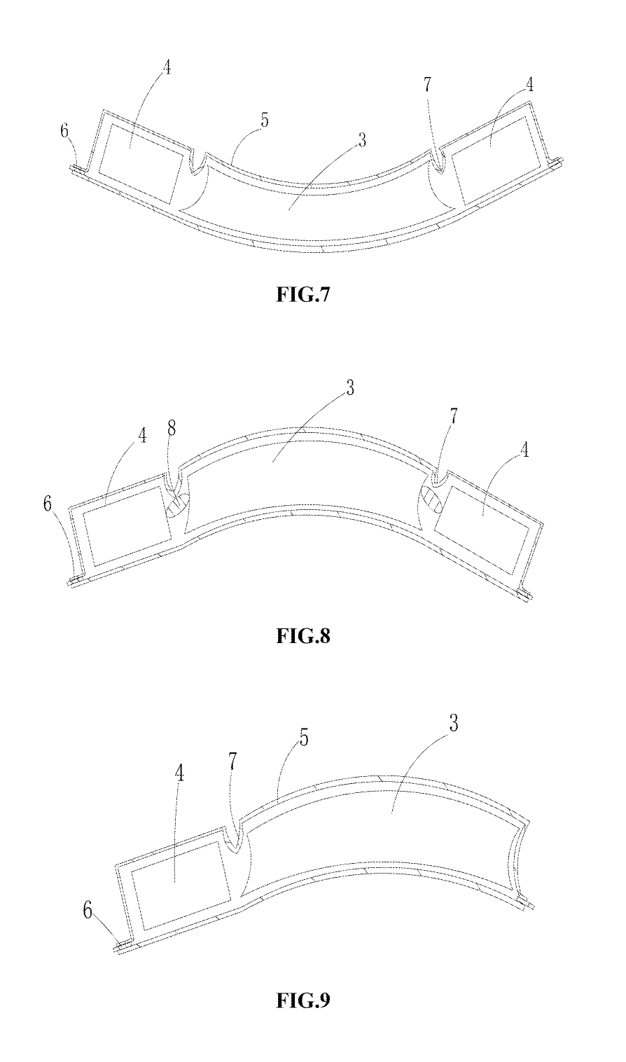

As shown in FIG. 6 and FIG. 7, when the flexible battery pack provided in this embodiment is bending, its bending part is the flexible cell 3, thus there is no effect of bending stress upon the battery performances, and moreover, its bendable radian and range are larger than those of the common cell 4, so high reliability is achieved. And the part that is not bending may be the common cells 4, in order to further lower the cost.

When the flexible battery pack in this embodiment is prepared, the flexible cell 3 and the two common cells 4 can be arranged in the packaging film 5 respectively at first, the flexible cell 3 is arranged between the two common cells 4, both the flexible cell tabs 31 and the common cell tabs 41 extend out of the packaging film 5, the flexible cell tabs 31 are connected in series with the common cell tabs 41 of the two common cells 4, the electrolyte is injected into the packaging film 5 after the packaging film 5 in the tab extending direction is top-sealed, and finally, the side seal edge of the packaging film 5 is sealed by the seal adhesive layer 6 after evacuation.

### Embodiment 2

As shown in FIG. 8, the difference from the embodiment 1 is that: the flexible cell 3 has a bendable radian of 120° (i.e. the flexible cell 3 is bendable within a range from 0° to 120°), the material of the seal adhesive layer 6 is polyimide, a adhesive buffer layer 8 is arranged between the flexible cell 3 and the common cell 4, the material of the adhesive buffer layer 8 is Acrylic resin, this ensures stress release of the flexible cell 3 and the common cells 4 in the process of mutual extrusion to reduce safety problems. And the flexible cell 3 is respectively connected with the two common cells 4 in parallel.

Other parts in this embodiment are the same as the embodiment 1, thus description is not repeated herein.

When the flexible battery pack in this embodiment is prepared, the flexible cell 3 and the two common cells 4 can be arranged in the packaging film 5 respectively at first, the flexible cell 3 is arranged between the two common cells 4, and meanwhile, the adhesive buffer layer 8 is arranged between the flexible cell 3 and the common cell 4 (e.g. a adhesive buffer plate can be arranged between the flexible cell 3 and the common cell 4), both the flexible cell tabs 31 and the common cell tabs 41 extend out of the packaging film 5, the flexible cell tabs 31 are connected in parallel with the common cell tabs 41 of the two common cells 4, the electrolyte is injected into the packaging film 5 after the packaging film 5 in the tab extending direction is top-sealed, and finally, the side seal edge of the packaging film 5 is sealed by the seal adhesive layer 6 after evacuation.

### Embodiment 3

As shown in FIG. 9, the difference from the embodiment 1 is that: the flexible cell 3 has a bendable radian of 30° (i.e. the flexible cell 3 is bendable within a range from 0° to 30°), the material of the seal adhesive layer 6 is Acrylic resin, furthermore, the cells comprise a flexible cell 3 and a common cell 4, and the flexible cell 3 and the common cell 4 are connected in series.

Other parts in this embodiment are the same as the embodiment 1, thus description is not repeated herein.

When the flexible battery pack in this embodiment is prepared, the flexible cell 3 and the common cell 4 can be arranged in the packaging film 5 respectively at first, both the flexible cell tabs 31 and the common cell tabs 41 extend out of the packaging film 5, the flexible cell tabs 31 are connected in series with the common cell tabs 41 of the common cell 4, the electrolyte is injected into the packaging film 5 after the packaging film 5 in the tab extending direction is top-sealed, and finally, the side seal edge of the packaging film 5 is sealed by the seal adhesive layer 6 after evacuation.

### Embodiment 4

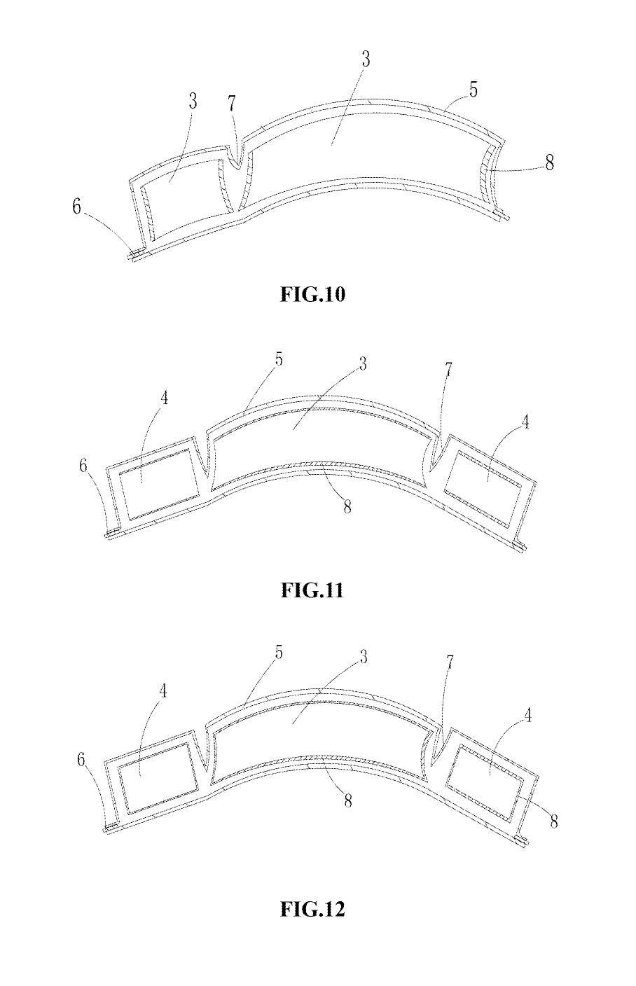

As shown in FIG. 10, the difference from the embodiment 1 is that: the material of the seal adhesive layer 6 is epoxy resin, the cells comprise two flexible cells 3, the two flexible cells 3 have a bendable radian of 150° (i.e. the flexible cells 3 are bendable within a range from 0° to 150°), a adhesive buffer layer 8 is arranged between the two flexible cells 3, the material of the adhesive buffer layer 8 is epoxy resin, the flexible cell tabs 31 of the two flexible cells 3 are connected in parallel, and the packaging film 5 located between the two flexible cells 3 is provided with a narrowing part 7; other parts in this embodiment are the same as the embodiment 1, thus description is not repeated herein.

When the flexible battery pack in this embodiment is prepared, the two flexible cells 3 can be arranged in the packaging film 5 respectively at first, and meanwhile, the adhesive buffer layer 8 is arranged between the two flexible cells 3 (e.g. the adhesive buffer layer 8 can be fixed on the surface of the flexible cell 3 and the common cell 4 in an adhesive manner), the flexible cell tabs 31 of the two flexible cells 3 extend out of the packaging film 5, the flexible cell tabs 31 of the two flexible cells 3 are connected in parallel, the electrolyte is injected into the packaging film 5 after the packaging film 5 in the tab extending direction is top-sealed, and finally, the side seal edge of the packaging film 5 is sealed by the seal adhesive layer 6 after evacuation.

### Embodiment 5

As shown in FIG. 11, the difference from the embodiment 1 is that: the flexible cell 3 has a bendable radian of 90° (i.e. the flexible cell 3 is bendable within a range from 0° to 90°), the material of the seal adhesive layer 6 is acrylate, a adhesive buffer layer 8 is arranged between the flexible cell 3 and the packaging film 5 and also between the common cell 4 and the packaging film 5, the material of the adhesive buffer layer 8 is styrene-butadiene rubber, this ensures stress release of the flexible cell 3 and the common cells 4 in the process of extrusion to reduce safety problems. The flexible cell 3 is connected with one of the common cells 4 in series and with the other one of the common cells 4 in parallel.

Other parts in this embodiment are the same as the embodiment 1, thus description is not repeated herein.

When the flexible battery pack in this embodiment is prepared, the flexible cell 3 and the two common cells 4 can be arranged in the packaging film 5 respectively at first, the flexible cell 3 is arranged between the two common cells 4, the adhesive buffer layer 8 is arranged between the flexible cell 3 and the packaging film 5 and also between the common cell 4 and the packaging film 5, both the flexible cell tabs 31 and the common cell tabs 41 extend out of the packaging film 5, the flexible cell tabs 31 are connected in series with the common cell tabs 41 of one of the common cells 4 and connected in parallel with the common cell tabs 41 of the other one of the common cells 4, the electrolyte is injected into the packaging film 5 after the packaging film 5 in the tab extending direction is top-sealed, and finally, the side seal edge of the packaging film 5 is sealed by the seal adhesive layer 6 after evacuation.

### Embodiment 6

As shown in FIG. 12, the difference from the embodiment 1 is that: the flexible cell 3 has a bendable radian of 10° (i.e. the flexible cell 3 is bendable within a range from 0° to 10°), the material of the seal adhesive layer 6 is Acrylic resin, a adhesive buffer layer 8 is arranged between the flexible cell 3 and the packaging film 5, between the common cell 4 and the packaging film 5 and also between the flexible cell 3 and the common cell 4, the material of the adhesive buffer layer 8 is ethylene-vinyl acetate copolymer, this ensures stress release of the flexible cell 3 and the common cells 4 in the process of extrusion to reduce safety problems.

Other parts in this embodiment are the same as the embodiment 1, thus description is not repeated herein.

When the flexible battery pack in this embodiment is prepared, the flexible cell 3 and the two common cells 4 can be arranged in the packaging film 5 respectively at first, the flexible cell 3 is arranged between the two common cells 4, the adhesive buffer layer 8 is arranged between the flexible cell 3 and the packaging film 5, between the common cell 4 and the packaging film 5 and also between the flexible cell 3 and the common cell 4, both the flexible cell tabs 31 and the common cell tabs 41 extend out of the packaging film 5, the flexible cell tabs 31 are connected in series with the common cell tabs 41 of the two common cells 4, the electrolyte is injected into the packaging film 5 after the packaging film 5 in the tab extending direction is top-sealed, and finally, the side seal edge of the packaging film 5 is sealed by the seal adhesive layer 6 after evacuation.

For a better understanding of the various embodiments illustrated in the present invention, the various components and their materials in Embodiments 1 to 6 are specifically summarized in Table 1, however, the embodiments of the present invention are not limited thereto.

TABLE 1
Various components and their materials in Embodiments 1 to 6

| | The Number | The Bendable | The Number | Connection | | | Cushion Adhesive |
|---|---|---|---|---|---|---|---|
| | of Flexible | Degree of | of Common | Relationship | | Cushion Adhesive | Between Cell and |
| Group | Cells | Flexible Cells | Cells | Between Cells | Seal Adhesive | Between Cells | Packaging Film |
| Embodiment 1 | 1 | 60° | 2 | Serial | Polypropylene | None | None |
| | | | | Connection | | | |
| Embodiment 2 | 1 | 120° | 2 | Parallel | Polyamide | Acrylic Resin | None |
| | | | | Connection | | | |
| Embodiment 3 | 1 | 30° | 1 | Parallel | Acrylic Resin | None | None |
| | | | | Connection | | | |
| Embodiment 4 | 2 | 150° | 0 | Parallel | Epoxy Resin | Epoxy resin | None |
| | | | | Connection | | | |
| Embodiment 5 | 1 | 90° | 2 | Serial | Acrylates | None | Styrene- |
| | | | | Connection, | | | Butadiene |
| | | | | Parallel | | | Rubber, |
| | | | | Connection | | | |
| Embodiment 6 | 1 | 10° | 2 | Serial | Acrylic Resin | Ethylene-Vinyl | Ethylene-Vinyl |
| | | | | Connection | | Acetate Copolymer | Acetate Copolymer |

In accordance with the principle above, appropriate variations and modifications could also be made to the above-mentioned embodiments in the present invention. Accordingly, the present invention is not limited to the embodiments disclosed and described hereinabove, and some modifications and variations made to the present invention shall still fall within the protective scope of the claims in the present invention. In addition, while some specific terms are employed in this specification, they are for ease of description only and do not constitute any limitation to the present invention.

What is claimed is:

1. A flexible battery pack, comprising a packaging film, an electrolyte filled in the packaging film, and at least two electrically-connected cells encapsulated in the packaging film, wherein at least one of the cells is a flexible cell.

2. The flexible battery pack according to claim 1, wherein the flexible cell has a bendable radian of 0°-180°.

3. The flexible battery pack according to claim 2, wherein the flexible cell has a bendable radian of 10°-120°.

4. The flexible battery pack according to claim 1, wherein the number of the flexible cell is smaller than the total number of the cells.

5. The flexible battery pack according to claim 1, wherein the packaging film between the cells is provided with a narrowing part.

6. The flexible battery pack according to claim 1, wherein a adhesive buffer layer is arranged between the cells.

7. The flexible battery pack according to claim 6, wherein the material of the adhesive buffer layer is at least one of the group consisting of Acrylic resin, epoxy resin, acrylic ester, styrene-butadiene rubber, ethylene-vinyl acetate copolymer, ethylene-acrylic acid copolymer and polyethylene terephthalate.

8. The flexible battery pack according to claim 1, wherein a adhesive buffer layer is arranged between the cell and the packaging film.

9. The flexible battery pack according to claim 8, wherein the material of the adhesive buffer layer is at least one of the group consisting of Acrylic resin, epoxy resin, acrylic ester, styrene-butadiene rubber, ethylene-vinyl acetate copolymer, ethylene-acrylic acid copolymer and polyethylene terephthalate.

10. The flexible battery pack according to claim 1, wherein the packaging film is sealed by a seal adhesive layer.

11. The flexible battery pack according to claim 10, wherein the material of the seal adhesive layer is at least one of the group consisting of polyimide, polypropylene, Acrylic resin, epoxy resin and acrylate.
